(19) United States
(12) Patent Application Publication
(10) Pub. No.: US 2026/0354363 A1
(43) Pub. Date: Nov. 12, 2026

(54) SYSTEM FOR ORGANIZING FISHING ACCESSORIES

(71) Applicant: Umpqua Feather Merchants, LLC, Louisville, CO (US)

(72) Inventors: Brent Bauer, Broomfield, CO (US); Russell Miller, Golden, CO (US); James Cotter, Broomfield, CO (US); Thomas Fryhover, Brighton, CO (US)

(73) Assignee: Umpqua Feather Merchants, LLC, Louisville, CO (US)

(21) Appl. No.: 19/674,969

(22) Filed: May 12, 2026

Related U.S. Application Data
(60) Provisional application No. 63/804,254, filed on May 12, 2025.

(51) Int. Cl. A01K 97/06

(52) U.S. Cl. CPC A01K 97/06

(57) ABSTRACT

An assembly for organizing fishing accessories is disclosed. The assembly includes one or more bases, each base including a magnet and an attachment feature configured to couple the base to a supporting device. A receptacle is configured to be releasably connected to a selected one of the one or more bases. The receptacle includes a flat portion having at least one receptacle magnet configured to magnetically couple the receptacle to the selected base. The receptacle further includes a receiving portion configured to support an item, such as a fishing fly, a fishing tool, or another fishing accessory.

### CROSS-REFERENCE TO RELATED APPLICATIONS

The present application claims priority to U.S. Provisional Patent Application Serial No. 63/804,254 filed May 12, 2025 and entitled “SYSTEM, METHOD AND DEVICE FOR ORGANIZING FISHING ACCESSORIES,” the entirety of which is incorporated by reference herein.

### TECHNICAL FIELD

The present disclosure relates to systems for organizing fishing accessories, and in particular, to a fly box for organizing fishing accessories.

### BACKGROUND

Fishing accessories are commonly used in a range of angling activities, including fly fishing and other fishing applications in which a user may carry flies, tools, line-related items, floatants, and other gear on a garment, pack, pouch, container, or other support article. In many settings, such accessories are preferably maintained in an organized manner such that selected items remain available for use while the user is moving between locations, wading, casting, handling fish, or otherwise operating in changing outdoor conditions. These activities can involve repeated transitions between storage and use, limited available carrying space, and differing support structures from one user to another. As fishing practices and equipment preferences vary, accessory organization arrangements may also be expected to accommodate different gear types, carrying styles, and access considerations while remaining suitable for use across a variety of wearable and non-wearable platforms.

Existing approaches can also involve tradeoffs between accessibility, retention, and adaptability in the field. In some arrangements, accessories may be stored in locations that are not readily accessible during use, which can interrupt workflow and require unnecessary handling. In other arrangements, items may shift, become tangled, or be insufficiently secured during movement, exposure to water, or repeated use, which can reduce organization and convenience. In addition, systems that are suited for one style of garment or support article may be less suitable for other carrying configurations, which can limit flexibility and make the arrangement of fishing gear more difficult to maintain in a consistent and efficient manner. Accordingly, there remains a need for improved systems for organizing fishing accessories in a manner that better addresses accessibility, secure retention, adaptability, and other practical considerations associated with fishing use.

### SUMMARY

According to an aspect of the disclosure, an assembly for organizing fishing accessories comprises: one or more bases, wherein the bases include a magnet and an attachment feature for coupling to a supporting device; and a receptacle configured to be releasably connected to a selected one of the one or more bases, wherein the receptacle comprises a flat portion including at least one receptacle magnet configured to magnetically couple the receptacle to the selected one of the one or more bases, and a receiving portion configured to support an item.

According to another aspect of the disclosure, a fly box for organizing fishing accessories comprises a bottom, a lid hinged to the bottom and configured to open the fly box for internal access, a plurality of corner magnets configured to retain the lid on the bottom in a closed position, a foam insert mounted to the lid and configured to restrict movement of one or more fishing flies within the fly box when the lid is in the closed position, a plurality of base magnets configured to retain an item on an exterior of the lid, and at least one magnetic plate mounted to the bottom and configured to magnetically couple the fly box to a magnetic base.

According to another aspect of the disclosure, a system for organizing fishing accessories comprises: a garment having a pocket and apertures in the pocket; one or more bases configured to be slidably inserted into the pocket and positioned through corresponding apertures in the pocket such that a proximal portion of each base is retained in the pocket, a distal portion of each base extends outwardly from the garment, and each base comprises a magnet and a clip; and an accessory configured to be releasably retained on one of the bases or on two of the bases.

### BRIEF DESCRIPTION OF THE DRAWINGS

FIG. 1 depicts an open perspective view of a fly box, according to an embodiment.

FIG. 2 depicts an exploded view of the fly box, according to an embodiment.

FIG. 3 depicts a perspective view of magnetic bases configured to support an accessory, according to an embodiment.

FIG. 4 depicts a perspective view of a bridge configured to connect the two bases, according to an embodiment.

FIG. 5 depicts a side view of the base with a clip, according to an embodiment.

FIG. 6 depicts a perspective view of an alternative magnetic base, according to an embodiment.

FIG. 7 depicts an exploded view of the alternative magnetic base, according to an embodiment.

FIG. 8 depicts a perspective view of a garment having a pocket and apertures, according to an embodiment.

FIG. 9 depicts a perspective view of bases installed on the garment, according to an embodiment.

FIG. 10 depicts a perspective view of a holder for a fly floatant mounted on the garment, according to an embodiment.

FIG. 11 depicts a perspective view of an extended fly patch configured to nest on two bases, according to an embodiment.

FIG. 12 depicts an exploded view of the extended fly patch, according to an embodiment.

FIG. 13 depicts a perspective view of an extended foam fly patch, according to an embodiment.

FIG. 14 depicts an exploded view of the extended foam fly patch, according to an embodiment.

FIG. 15 depicts a perspective view of a tool catch, according to an embodiment.

FIG. 16 depicts a perspective view of a fly patch, according to an embodiment.

FIG. 17 depicts an exploded view of the fly patch, according to an embodiment.

FIG. 18 depicts a perspective view of a tippet tower, according to an embodiment.

FIG. 19 depicts an exploded view of the tippet tower, according to an embodiment.

FIG. 20 depicts a perspective view of an extended tool catch, according to an embodiment.

FIG. 21 depicts an exploded view of the extended tool catch, according to an embodiment.

FIG. 22 depicts a perspective view of a zinger, according to an embodiment.

FIG. 23 depicts an exploded view of the zinger, according to an embodiment.

FIG. 24 depicts an open perspective view of a box for organizing fishing flies, according to an embodiment.

FIG. 25 depicts a perspective view of a magnetic work station, according to an embodiment.

FIG. 26 depicts an exploded view of the magnetic work station, according to an embodiment.

FIG. 27 depicts a perspective view of a magnetic base mounted to a rigid object, according to an embodiment.

FIG. 28 depicts a perspective view of a magnetic base strap holder, according to an embodiment.

FIG. 29 depicts a perspective view of a magnetic dry shake holder, according to an embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

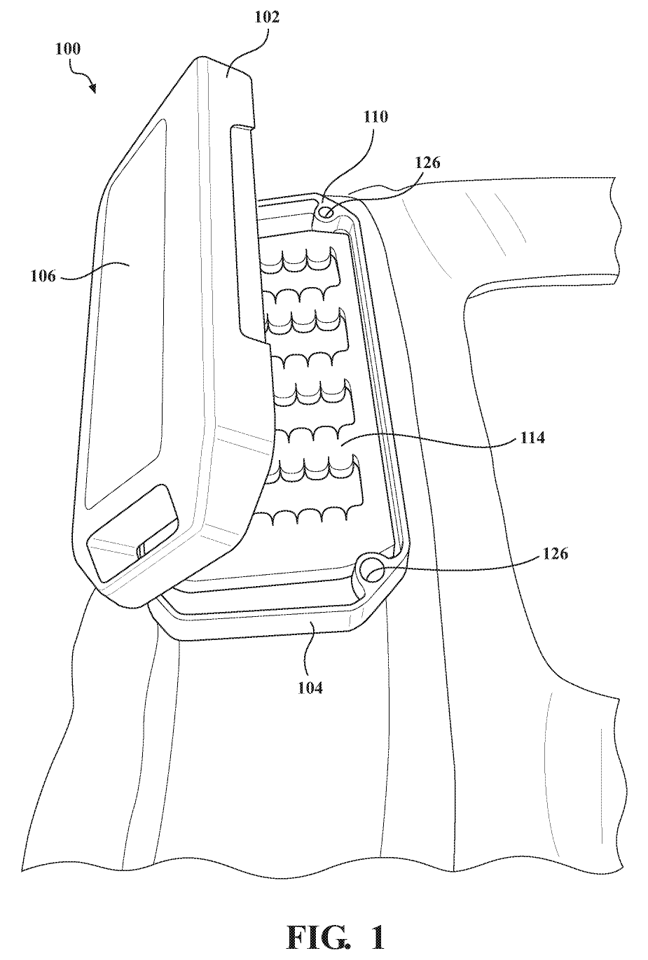

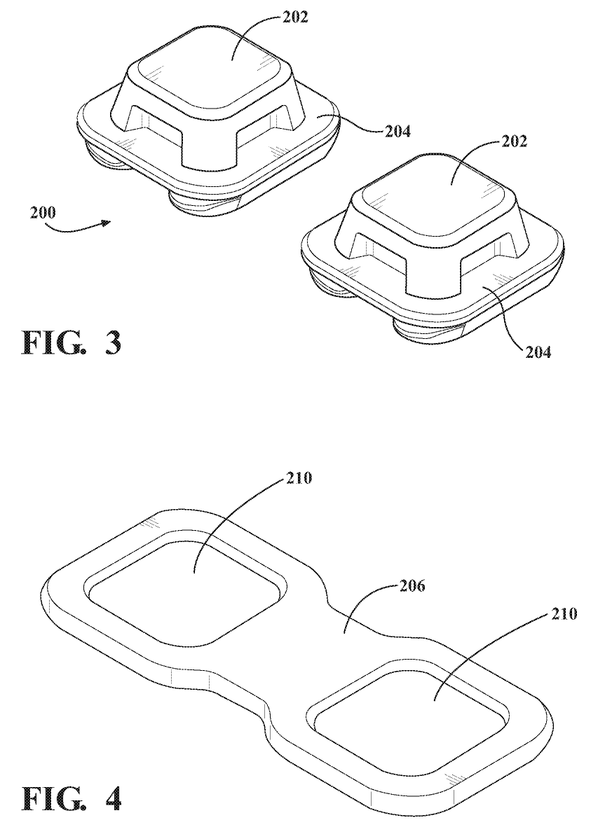

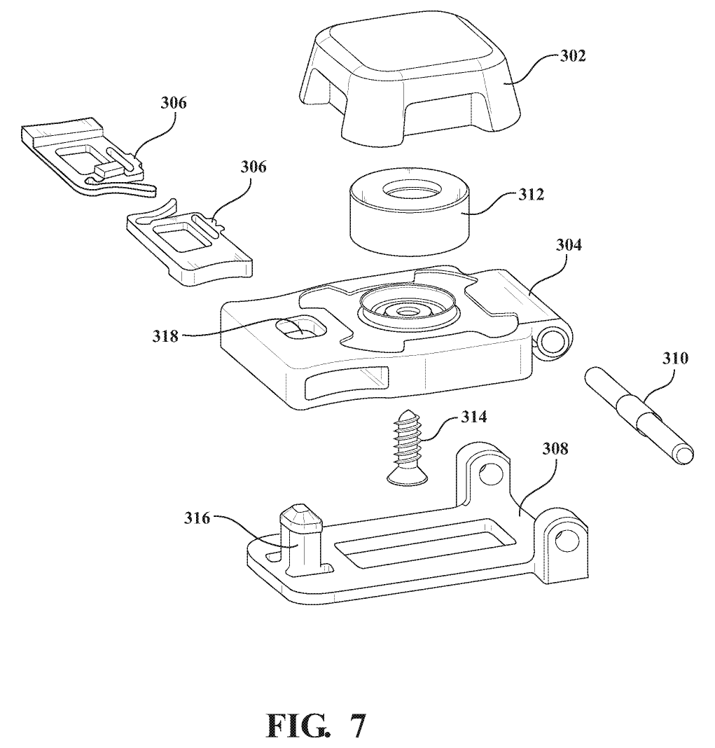

Referring now to FIGS. 1-7, a system for organizing fishing accessories is illustrated in which an accessory is configured to be releasably retained on one or more magnetic bases 200, 300. In the illustrated figure group, the accessory is a fly box 100, and the bases 200 are shown as magnetic bases 200 in FIGS. 3-5 and as an alternative magnetic base 300 in FIGS. 6-7. As described below, the fly box 100 can be magnetically retained on one base 200, 300 for a compact mounting arrangement or on two bases 200, 300 for enhanced stability, depending on the size, weight, and intended use of the accessory.

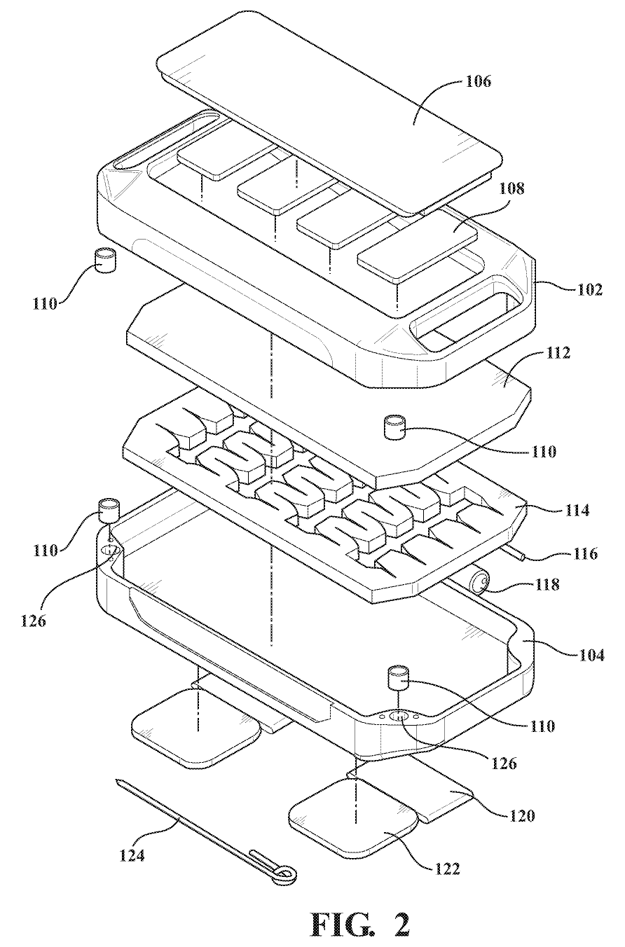

As shown in FIGS. 1 and 2, the fly box 100 includes a base top 102 and a base bottom 104 that cooperate to define a body of the fly box 100. The base top 102 is positioned above the base bottom 104 and is coupled thereto by a hinge 118. A hinge pin 116 is received within the hinge 118 and defines a pivot axis about which the base top 102 is pivotable relative to the base bottom 104 between open and closed positions. The hinge pin 116 may be stainless steel. A plurality of base top magnets 108 are positioned in a recess defined by the base top 102. A cover 106 overlies the recess to close in the base top magnets 108 such that an item may be retained on an exterior of the lid along the cover 106. The cover 106 may be injection molded and the base top magnets 108 may be made of neodymium.

The fly box 100 further includes the plurality of corner magnets 110 configured to retain the lid on the bottom in a closed position. The corner magnets 110 are positioned adjacent corner regions of the fly box 100 such that, when the base top 102 is moved toward the base bottom 104, magnetic attraction between corresponding structures retains the fly box 100 in the closed position. The distribution of the corner magnets 110 at spaced locations can improve closing stability and reduce unintended opening during use, transport, or movement of a garment or other object carrying the fly box 100. Additionally, each of the corner magnets 110 are positioned in a recess 126 in the corner regions such that the corner magnets 110 are secured within the recess 126. According to the shown embodiment in FIG. 2, the corner magnets 110 are embedded in a series of recesses at corners of the base top 102 and base bottom 104.

The fly box 100 further includes a fly mold 114 configured to support or organize one or more fishing flies. The fly mold 114 is coupled to an interior surface of the base bottom 104 and may be arranged opposite the base top 102 such that, when the fly box 100 is opened, the fly mold 114 is exposed and accessible for receiving, organizing, and retaining one or more fishing flies.

The fly box 100 also includes a dyecut foam insert 112 mounted to the base top 102. The dyecut foam insert 112 contains an adhesive laminant layer for attachment to the base top 102. The dyecut foam insert 112 may be mounted adjacent an interior surface of the base top 102 The foam insert 112 may permit orderly placement of multiple fishing flies while reducing movement of the fishing flies when the fly box 100 is closed.

The fly box 100 further includes at least two magnetic plates 122 that are secured to an underside of the base bottom 104. In other embodiments, epoxy 120 is provided on the underside of the base bottom 104 as a directional guide that indicates to a user which direction to pull on to release the fly box 100 from the bases 200. In additional embodiments, a textured surface may be used in place of the epoxy 120. The magnetic plates 122 may be made of stainless steel with light resurface polishing. The magnetic plates 122 cooperate with magnets of the bases 200 such that the fly box 100 may be magnetically and releasably retained on one base 200 or on two bases 200. In this manner, the magnetic plates 122 define an interface on the fly box 100 that allows the accessory to attach to distal portions of bases 200 extending outwardly from a garment, rigid object, or other support structure. The spaced arrangement of the magnetic plates 122 can facilitate stable mounting on two bases 200 positioned in a corresponding spaced relationship.

Additionally, a clothing pin 124 is also associated with the fly box 100. The clothing pin 124 may correspond to a pin that can be deployed to mechanically attach the fly box 100 to another object without magnetic force. The clothing pin 124 may attach to, amongst other things, a piece of clothing, a garment, or anything else that does not require a magnetic coupling. The clothing pin 124 may be stainless steel. The clothing pin 124 thereby provides an alternative attachment mode when a magnetic mounting surface or compatible bases are not used. Accordingly, the fly box 100 may be secured either magnetically through the magnetic plates 122 or mechanically through the clothing pin 124, thereby expanding the range of garments, containers, boxes, ice chests, handles, water bottles, and other objects to which the fly box 100 may be attached.

FIG. 3 illustrates magnetic bases 200 that may receive and support the fly box 100. Each magnetic base 200 includes a base top 202 and a base bottom 204. The base top 202 and the base bottom 204 may be injection molded. As illustrated, the base top 202 forms an outwardly projecting distal portion that is shaped to nest with a complementary portion of an accessory, and the base bottom 204 forms a proximal portion that is secured to a garment or another object. The magnetic bases 200 each comprise a magnet positioned in between the base top 202 and the base bottom 204 The base tops 202 of the bases 200 may have recesses that are complementary in shape to protrusions on the accessory, thereby improving alignment and resisting lateral movement when the accessory is mounted.

FIG. 4 illustrates a bridge 206 configured to nest with and connect two of the magnetic bases 200. The bridge 206 includes two openings 210, each of which are configured to receive a base top 202 of a corresponding magnetic base 200. The bridge 206 may extend between adjacent bases 200 such that the bases 200 are maintained in a desired spacing and orientation relative to one another. The bridge 206 may be flexible and may include protrusions that engage recesses on the two magnetic bases 200. By connecting two bases 200 together, the bridge 206 may simplify installation on a garment and may help maintain a consistent positional relationship for accessories configured to nest on two bases 200, including larger accessories such as the fly box 100.

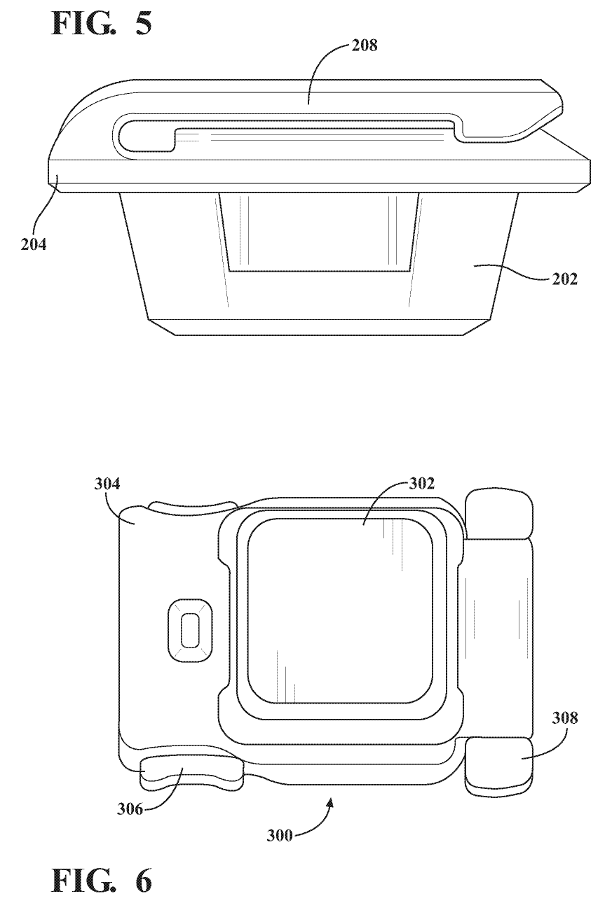

FIG. 5 illustrates a side view of one of the magnetic bases 200 and further depicts a magnetic base clip 208. The magnetic base clip 208 may be configured to mechanically retain the base on another object without magnetic force. In this way, the base may be attached to a garment, pocket, strap, sling, bag, pouch, backpack, or other support structure by mechanical engagement, while the outwardly extending portion of the base remains available to magnetically and releasably retain the accessory. The side profile of FIG. 5 also illustrates that the magnetic base top 202 projects outwardly relative to the magnetic base bottom 204, which can create a raised distal portion for engagement with the magnetic plates 122 of the fly box 100 and for nesting with a complementary accessory surface.

FIGS. 6 and 7 illustrate an alternative magnetic base 300 which may be used in place of the magnetic bases 200 of FIGS. 3-5. The alternative magnetic base 300 includes a cap 302, a bottom 304, a button 306, and an arm 308. The bottom 304 defines a support body of the alternative magnetic base 300, and the cap 302 is positioned above the bottom 304 to form an upper portion configured to engage an accessory. The magnet 312 is positioned between the cap 302 and the bottom 304 such that the alternative magnetic base 300 can releasably and magnetically retain the accessory.

The arm 308 extends from a side region of the bottom 304 and is coupled to the bottom 304 by the pin 310. The pin 310 defines a hinge connection that permits the arm 308 to pivot between an open position and a closed position. In the open position, the arm 308 allows a portion of a garment, strap, pocket edge, sling, pack material, or other support structure to be received between the arm 308 and the bottom 304. In the closed position, the arm 308 clamps the supporting article against the bottom 304 to secure the alternative magnetic base 300 to the supporting article. The arm 308 also includes a protrusion 316 that extends from the arm 308 and is configured to be received within an opening 318 of the base body 304, thereby securing the arm 308 beneath the base body 304.

The button 306 may be actuated to release, unlock, or reposition part of the alternative magnetic base 300. The screw 314 secures or assembles portions of the alternative magnetic base 300 so that the cap 302, the bottom 304, the arm 308, the button 306, and the magnet 312 are maintained in an assembled configuration. In this arrangement, the hinged arm 308 and the button 306 provide a positive closure for retaining the alternative magnetic base 300 on the supporting article, while the magnet 312 provides magnetic retention for the accessory.

Referring again to FIGS. 1-7, the fly box 100 may be used with the magnetic bases 200 of FIGS. 3-5 or with the alternative magnetic base 300 of FIGS. 6-7, depending on the desired mounting configuration. Taken together, FIGS. 1-7 illustrate a modular accessory-and-base arrangement for organizing fishing accessories. The fly box 100 provides internal access and storage while also incorporating structures, including the magnetic plates 122 and the clothing pin 124, that permit magnetic attachment and mechanical attachment. The magnetic bases 200 and the alternative magnetic base 300 provide selectively mountable supports that can be attached to garments or other objects and that can releasably retain the fly box 100 on one base or two bases. This arrangement may allow a user to position the fly box 100 at a convenient location, remove the fly box 100 when desired, and reattach the fly box 100 without requiring permanent fixation to the supporting object.

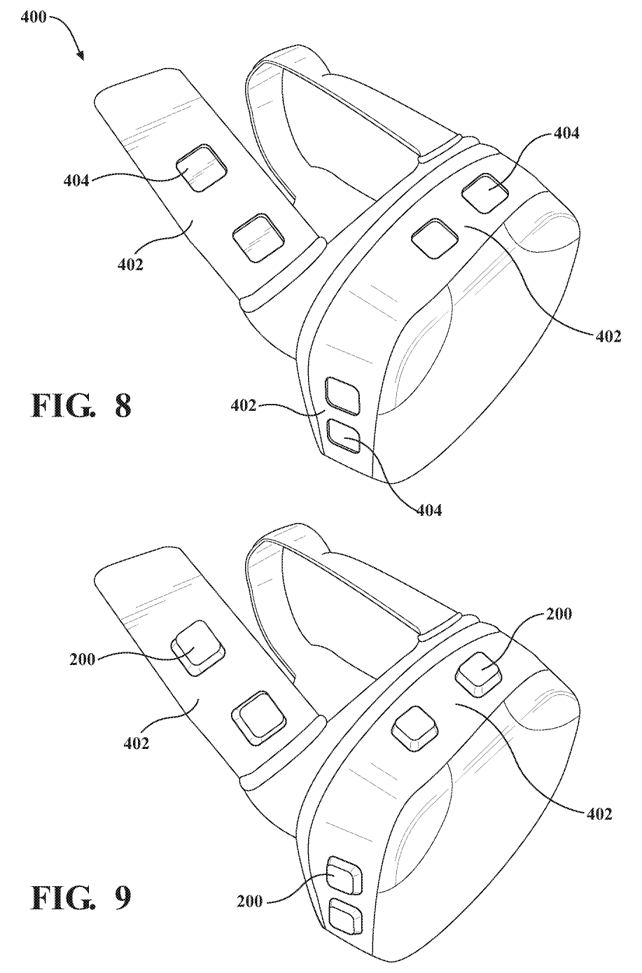

FIGS. 8-10 illustrate a garment-based mounting arrangement in which the magnetic bases 200 are carried by a wearable article such that accessories may be selectively attached at outwardly accessible locations on the garment 400. This figure group shows how the base structures previously described with respect to FIGS. 3-7 can be incorporated into a garment platform that supports removable accessory placement during use. The garment 400 provides a stable and convenient support structure for the magnetic bases 200, 300 while allowing the user to position accessories at locations that are readily accessible during fishing or other outdoor activity.

The garment 400 may include one or more pockets 402 and a plurality of apertures 404 formed in the material of the garment 400 to access the pockets 402.The garment 400 includes two stacked layers that define the pocket 402 therebetween, and a top layer of the two stacked layers defines the apertures 404 to provide access to the pocket 402 from an exterior of the garment 400. The garment 400 may comprise of fabric or a polymer. The pockets 402 are sized and arranged to receive magnetic bases 200, and the apertures 404 are located to allow portions of the magnetic bases 200 to project outwardly from the garment 400. In this manner, the garment 400 serves as a mounting platform that carries the bases 200 in an organized manner while leaving the accessory-engagement portions of the bases 200 exposed at the exterior of the garment. The garment 400 can thereby support removable accessories without requiring permanent installation of each accessory directly onto the garment structure itself.

The pockets 402 may be closable or sealable with a zipper, a hook, or a loop fastener. The apertures 404 cooperate with the pockets 402 so that a proximal portion of a magnetic base 200 can remain disposed inside the garment structure while a base top 202 of the magnetic base 200 extends outwardly for attachment to an accessory.. The garment 400 may be configured as a vest, shirt, sling, bag, pouch, backpack, or another article adapted to carry fishing accessories.

The garment 400 may support multiple magnetic bases 200 at spaced locations. By positioning the magnetic bases 200 in a selected relationship relative to one another, the garment 400 can accommodate accessories configured for attachment to a single base 200 or for attachment across two bases 200. This can be beneficial for supporting accessories of different sizes, weights, and configurations while maintaining a secure and organized layout on the garment exterior.

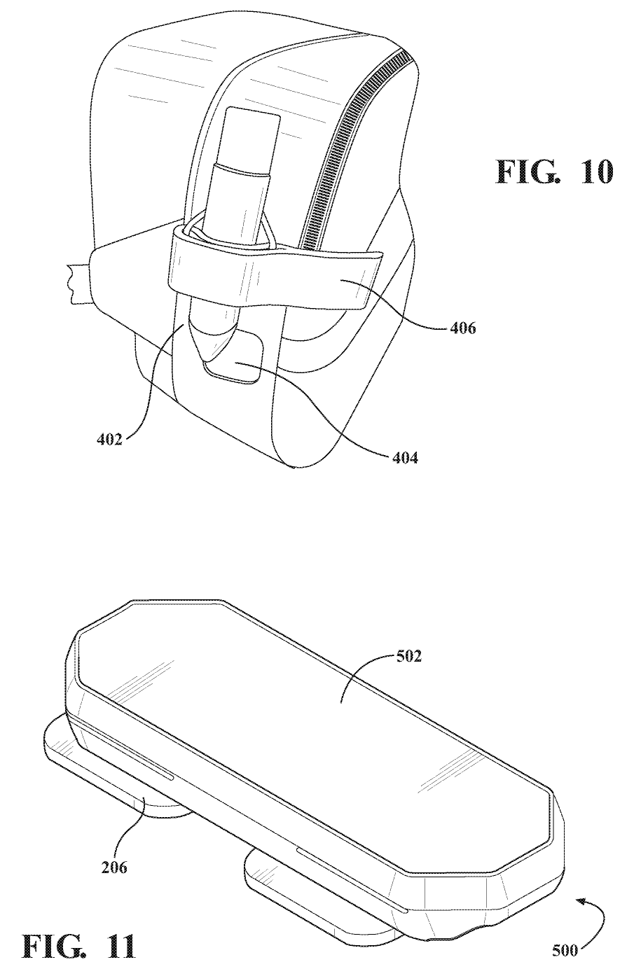

Referring specifically to FIG. 10, the garment-based arrangement is shown with an accessory mounted to an exposed base location. In the illustrated example, the garment 400 includes the pockets 402 and the apertures 404, and a fly floatant holder 406 that is supported at an exterior portion of the garment 400 for convenient user access. The fly floatant holder 406 is supported by the magnetic bases 200, which are installed within the garment 400 such that portions of the magnetic bases 200 are outwardly accessible through the apertures 404. The fly floatant holder 406 includes one or more magnets configured to magnetically couple to the corresponding magnets of the magnetic bases 200, thus releasably retaining the fly floatant holder 406 on the garment 400

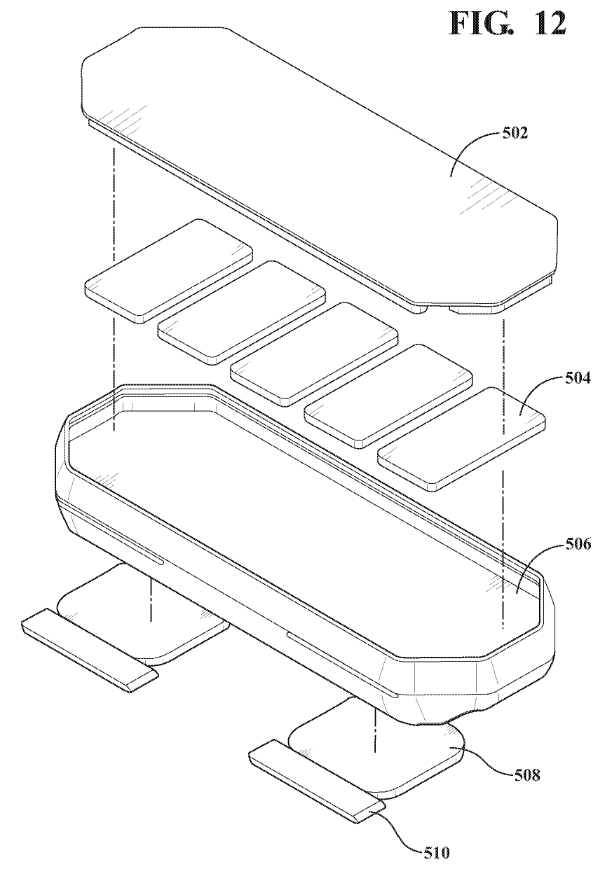

FIGS. 11 and 12 illustrate an extended fly patch 500 that may be supported by the garment-mounted base arrangement described above. The extended fly patch includes a molded cover 502, a molded base 506, a plurality of magnets 504, a plurality of magnetic plates 508, and epoxy 510. The molded base 506 supports the magnets 504 and the magnetic plate 508, and the molded cover 502 is positioned relative to the molded base 506 to at least partially enclose the internal components.

The molded base 506 defines a recess sized to receive the plurality of magnets 504. The magnets 504 are positioned within the recess of the molded base 506 such that the magnets 504 can be retained within the extended fly patch 500 and used to releasably and magnetically retain a fishing fly or a fishing tool on an outer surface thereof. The molded cover 502 is positioned over the compartment or recess and coupled to the molded base 506, thereby covering the magnets 504 and closing the recess to retain the magnets 504 within the molded base 506. The molded base 506 and the molded cover 502 may be injection molded.

The magnetic plates 508 are secured to a bottom surface of the molded base 506 such that the extended fly patch 500 can be magnetically and releasably retained on the bases 200. The extended fly patch 500 is shown in association with the bridge 206. The bridge 206 may maintain spacing and relative position of the two bases 200 such that the extended fly patch 500 can be supported across both bases 200 in a coordinated manner. In this arrangement, the extended fly patch 500 may provide a larger accessory body than a fly patch configured to nest on one of the bases 200, and the larger span can improve stability when the accessory is mounted across two of the bases 200.

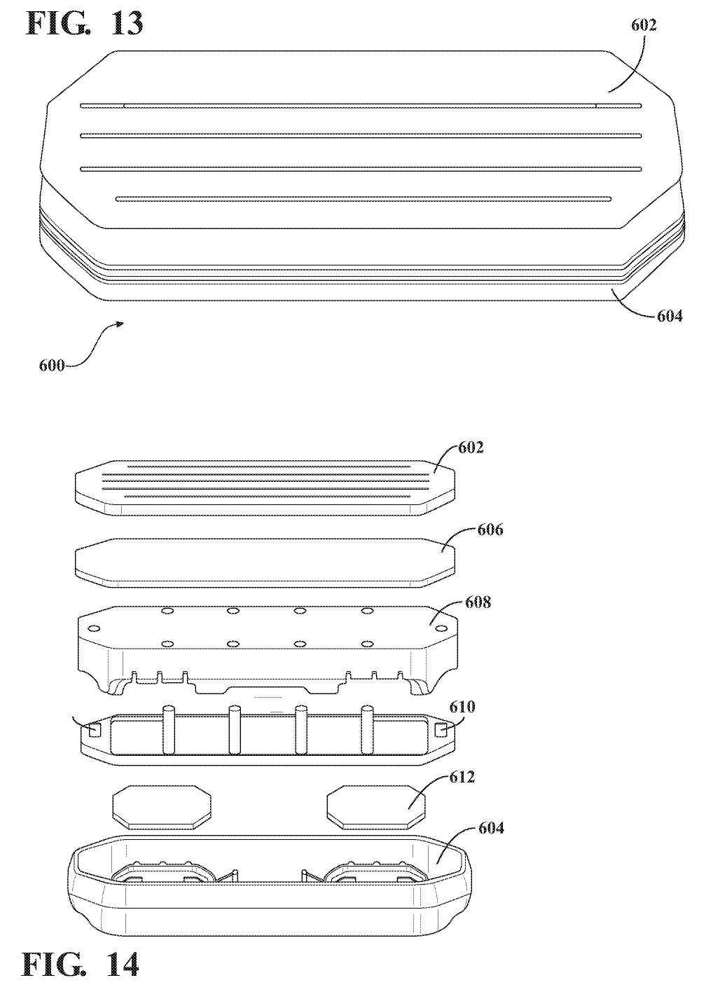

FIGS. 13 and 14 illustrate an extended foam fly patch 600 that can provide a fly-retention surface while also being adapted for releasable retention on one or more of the magnetic bases 200 described above. As shown, the extended foam fly patch 600 includes a foam insert 602, a bottom 604, tape 606, thermoplastic rubber (TPR) 608, a spacer 610, and one or more magnetic plates 612. The bottom 604 provides a structural support body for the extended foam fly patch 600 and supports the remaining components. The foam 602 is positioned at an upper side of the extended foam fly patch 600 and defines an exterior fly-retention surface having a plurality of elongated slots 614 extending along a length of the extended foam fly patch 600. The elongated slots 614 may receive hooks or other portions of fishing flies such that the fishing flies may be selectively retained on the exterior fly-retention surface.

The foam 602 is positioned above the tape 606, and the tape 606 is positioned between the foam 602 and the TPR 608 to secure the foam 602 relative to the TPR 608. The spacer 610 is positioned below the TPR 608 and above the bottom 404 to establish spacing between the TPR 608 and the bottom 604. The TPR 608 acts as a transitional material that forms a flat support surface and promotes adhesion between the foam 602 and the underlying structure.

The bottom 604 defines a recess sized to receive the magnetic plates 612, and the magnetic plates 612 are positioned within the recess of the bottom 604 such that the extended foam fly patch 600 may be magnetically and releasably retained on one or more magnetic bases 200. The magnetic plate 612 may be made of stainless steel with light resurface polishing. The extended foam fly patch 600 may be mounted at an exterior location on a garment, pack, pouch, or other support structure by magnetically coupling the magnetic plate 612 to the one or more magnetic bases 200. By incorporating the magnetic plate 612 into the extended foam fly patch 600, the extended foam fly patch 600 can be mounted, removed, and repositioned while remaining compatible with the previously described magnetic base arrangements.

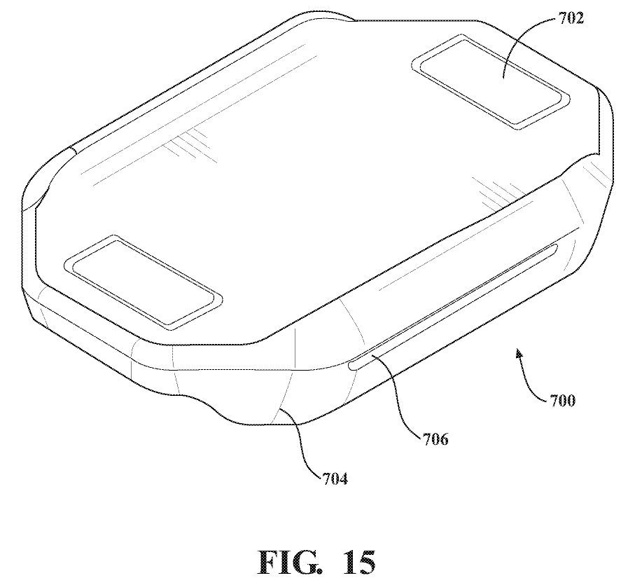

FIG. 15 illustrates a magnetic tool catch 700. The magnetic tool catch 700 may be used with the previously described base system and may be configured to nest on one of the bases 200. The magnetic tool catch 700 includes magnets 702 and a molded base 704. The magnets 702 are positioned at an exterior portion of the magnetic tool catch 700 such that the magnetic tool catch 700 is configured to retain an object on an exterior of the magnetic tool catch 700. The molded base 704 supports the magnets 702 and defines a body of the magnetic tool catch 700. As illustrated, the magnets 702 are arranged at spaced locations on the magnetic tool catch 700 such that the magnetic tool catch 700 can present multiple magnetic retention regions on an outer surface. By incorporating the magnets 702 into the magnetic tool catch 700, the magnetic tool catch 700 may be mounted on one of the bases 200 while also providing a magnetic retention function for another object at an outwardly accessible exterior location.

In other embodiments, epoxy 706 is provided on the molded base 704 as a directional guide that indicates to a user which direction to pull to release the magnetic tool catch 700 from the bases 200. The epoxy 706 may be dyed blue or another color to make the directional guide more visible. In additional embodiments, a textured surface may be used in place of the epoxy 706 to indicate the direction in which the user should pull to release the magnetic tool catch 700 from the bases 200.

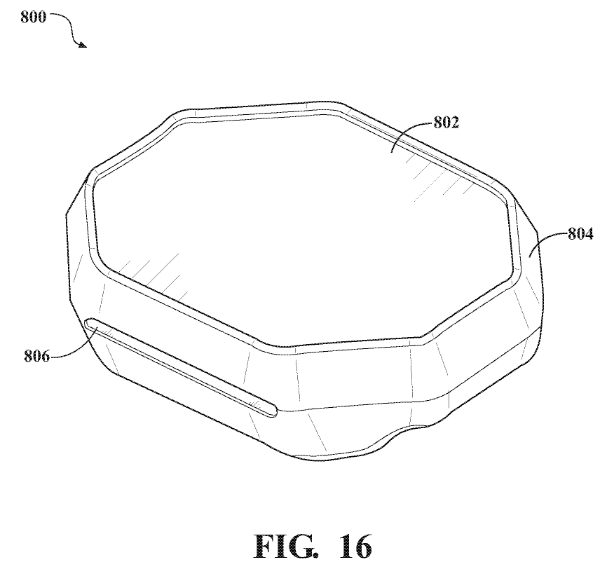

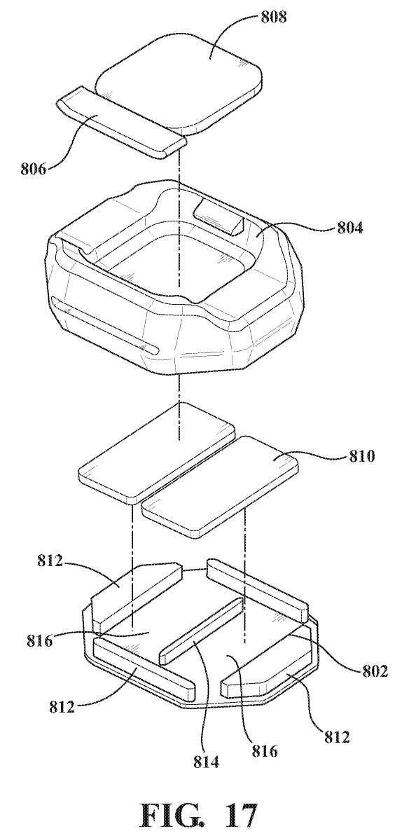

FIGS. 16 and 17 illustrate another magnetic fly patch for use with the previously described base system. The magnetic fly patch 800 may be configured to nest on one of the bases 200 and may include a molded cover 802, a molded base 804, a magnetic plate 808, and magnets 810.The molded cover 802 forms an outer portion of the magnetic fly patch 800 and can define the exterior surface on which a fishing fly or tool is retained. The molded cover 802 is positioned above the magnets 810, and the molded base 804 is positioned below the magnets 810 such that the molded cover 802 and the molded base 804 cooperate to house the magnets 810 within the magnetic fly patch 800. The molded cover 802 includes four side protrusions 812 and a center protrusion 814 that are positioned on the underside of the molded cover 802. These protrusions 812, 814 define a recess 816 that is configured to receive the magnets 810. The magnets 810 may be made of neodymium magnets. The magnetic plate 808 is positioned within a recess defined in the molded base 804 such that the magnetic fly patch 800 may be magnetically and releasably retained on one of the bases 200. The magnetic plate 808 may be made of stainless steel with light resurface polishing having dimensions of about 22 mm by 22 mm by 1.5 mm.

In other embodiments, epoxy 806 is provided on the molded base 804 as a directional guide that indicates to a user which direction to pull to release the magnetic fly patch 800 from one of the bases 200. The epoxy 806 may be dyed blue or another color to make the directional guide more visible. In additional embodiments, a textured surface may be used in place of the epoxy 806 to indicate the direction in which the user should pull to release the magnetic fly patch 800 from the base 200.

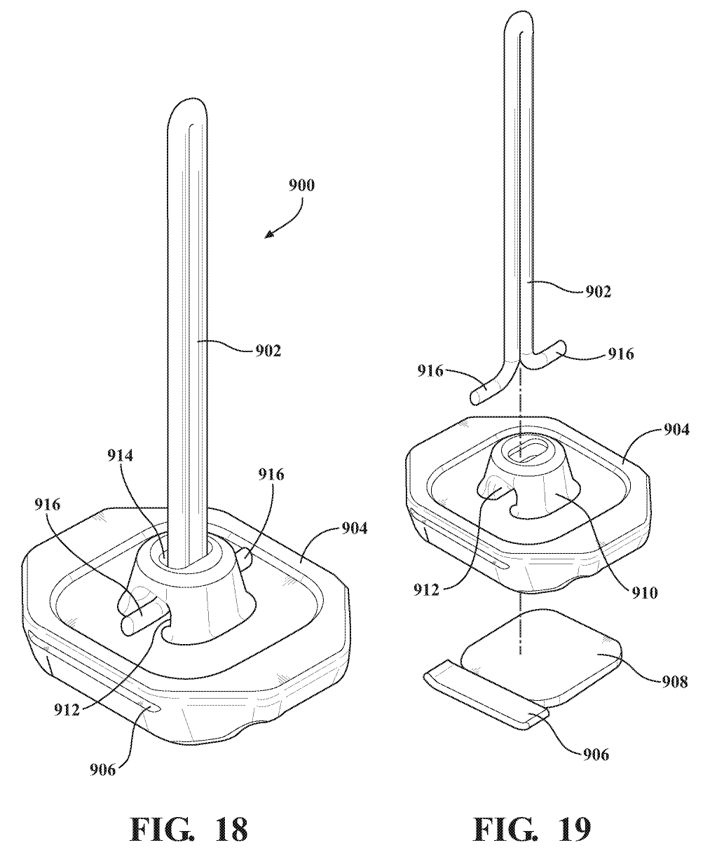

FIGS. 18 and 19 illustrate a tippet tower 900 for use with the previously described base system. The tippet tower 900 may be configured to nest on one of the bases 200 and may include a cord 902, a molded base 904, and a magnetic plate 908. The molded base 904 defines a body of the tippet tower 900 and supports the cord 902 relative to the remainder of the accessory. The molded base 904 includes a protrusion 910 that extends upwardly from a top of the molded base 904. The protrusion 910 defines two side holes 912 positioned along opposing sides of the protrusion 910 and a top hole 914 positioned at an upper end of the protrusion 910. The top hole 914 is configured to receive a main post of the cord 902, and the two side holes 912 are configured to receive corresponding legs 916 of the cord 902 such that the cord 902 is secured to and extends outwardly from the molded base 904. The magnetic plate 908 is positioned on the bottom of the molded base 904 such that the tippet tower 900 can be magnetically and releasably retained on one of the bases 200. The magnetic plate 908 may be made of stainless steel with light resurface polishing.

In other embodiments, epoxy 906 is provided on the molded base 904 as a directional guide that indicates to a user which direction to pull to release the tippet tower 900 from the bases 200. The epoxy 906 may be dyed blue or another color to make the directional guide more visible. In additional embodiments, a textured surface may be used in place of the epoxy 906 to indicate the direction in which the user should pull to release the tippet tower 900 from the bases 200.

Additionally, the tippet tower 900 may be carried at an outwardly accessible location on a garment, pack, pouch, or other support structure by releasable attachment to one of the previously described bases. The outwardly extending cord 902 allows the tippet tower 900 to support a tippet in a manner that remains accessible to the user during activity. FIG. 18 thereby illustrates that the accessory system can include line-management accessories in addition to fly-retention accessories and storage accessories.

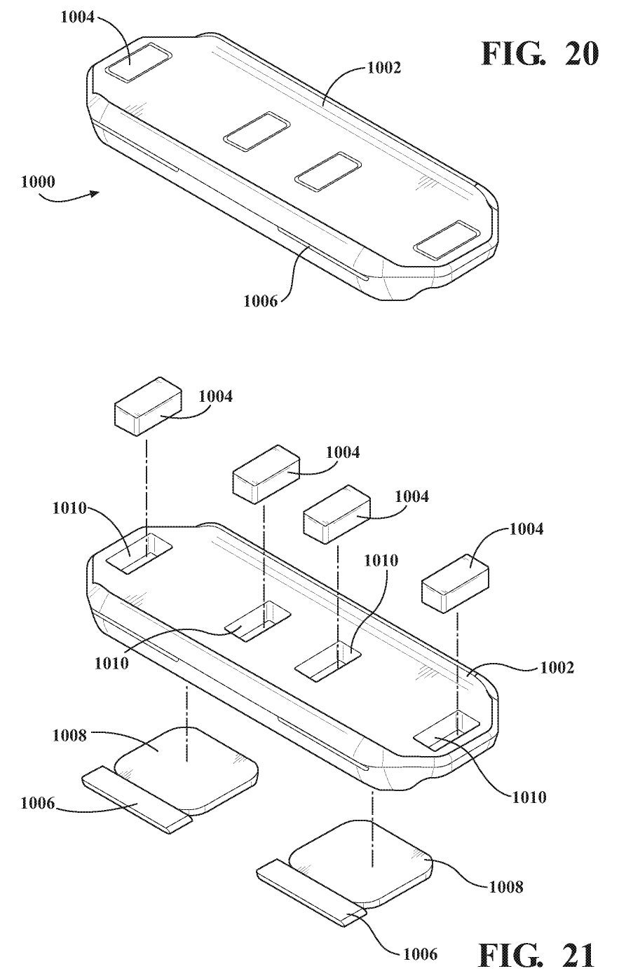

FIGS. 20 and 21 illustrate an extended tool catch 1000 for use with the previously described base system. The extended tool catch 1000 is configured to nest on two of the bases 200 and includes a molded base 1002, magnets 1004, and a magnetic plate 1008. The extended tool catch 1000 is configured to retain a object on an exterior of the extended tool catch 1000 while also being magnetically and releasably retained on two of the bases 200. In this manner, FIGS. 20 and 21 illustrate an accessory configured to span two bases 200 and provide an enlarged or extended tool-retention structure.

The molded base 1002 defines a body of the extended tool catch 1000 and supports the magnets 1004 relative to the remainder of the accessory. The magnets 1004 are positioned at spaced locations on the extended tool catch 1000 such that the extended tool catch 1000 can define multiple magnetic retention regions on an exterior thereof. By arranging the magnets 1004 across the extent of the extended tool catch 1000, the extended tool catch 1000 can retain one or more magnetic objects at an outwardly accessible location. Additionally, each of the magnets 1004 are configured to be received in a recess 1010, securing the magnets 1004 to the molded base 1002.

The magnetic plate 1008 is coupled to the bottom of the molded base 1002 such that the extended tool catch 1000 can be magnetically and releasably retained on two of the bases 200. The magnetic plate 1008 may be made of stainless steel with light resurface polishing. In other embodiments, epoxy 1006 is provided on the molded base 1002 as a directional guide that indicates to a user which direction to pull to release the extended tool catch 1000 from the bases 200. The epoxy 1006 may be dyed blue or another color to make the directional guide more visible. In additional embodiments, a textured surface may be used in place of the epoxy 1006 to indicate the direction in which the user should pull to release the extended tool catch 1000 from the bases 200. FIGS. 20 and 21 thereby illustrate that the extended tool catch 1000 may be carried at an exterior location on a garment, pack, pouch, or other support structure while presenting a magnetic retention surface for selectively holding a magnetic object.

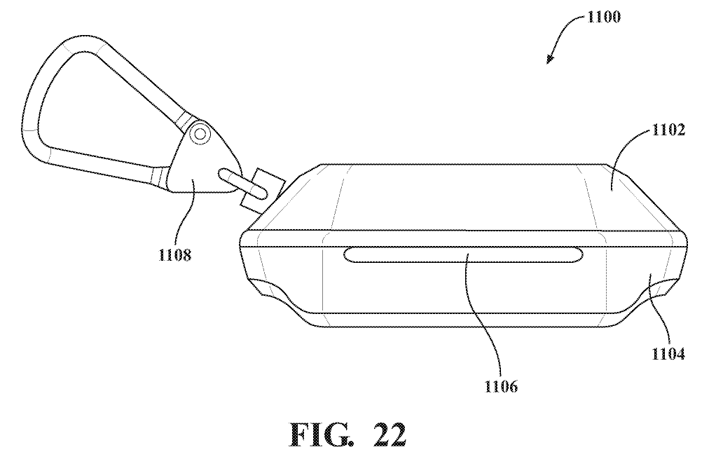

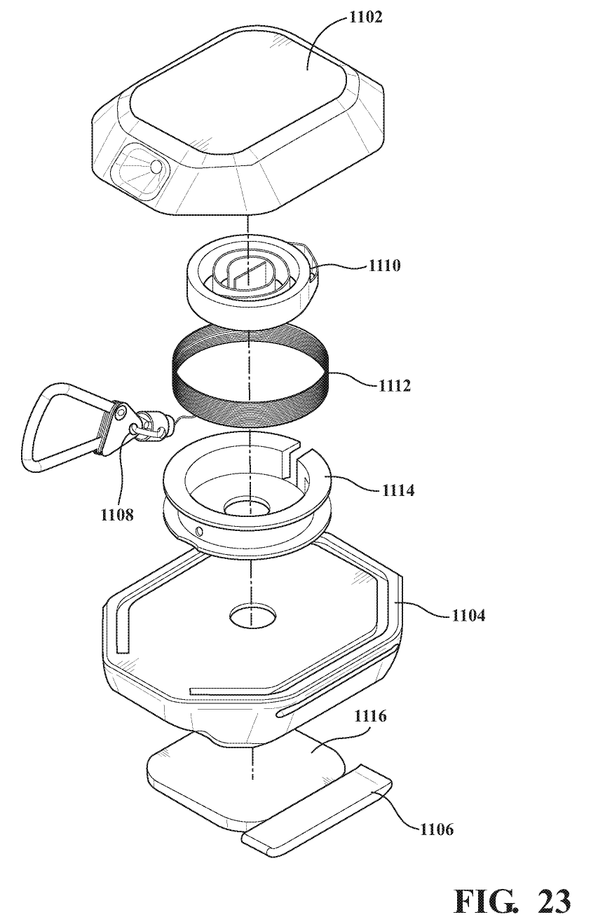

FIGS. 22 and 23 illustrate a magnetic zinger 1100 for use with the previously described base system. The magnetic zinger 1100 may be configured to nest on one of the bases 200 and may include a molded top 1102, a molded base 1104, a hook 1108, a wound spring 1110, a flat cord 1112, a retractor molded spool 1114, and a magnetic plate 1116. The magnetic zinger 1100 may provide a retractable accessory-retention arrangement while also being magnetically and releasably retained on one of the bases 200. In this manner, FIGS. 22 and 23 illustrate an accessory configured to support a tool or other article on a retractable line at an outwardly accessible location.

The molded top 1102 and the molded base 1104 are coupled to each other to define a body of the magnetic zinger 1100. The hook 1108 extends from the body and may be used to connect a tool, accessory, or other article to the magnetic zinger 1100. The molded top 1102 and the molded base 1104 and may secure one or more components of the magnetic zinger 1100 relative to the body. The wound spring 1110, the flat cord 1112, and the retractor molded spool 1114 cooperate to define a retractable mechanism by which the hook 1108 can be extended away from the body of the magnetic zinger 1100 and retracted back toward the body when not in use. The magnetic plate 1116 is coupled to the bottom of the molded base 1104 such that the magnetic zinger 1100 can be magnetically and releasably retained on one of the bases 200. The magnetic plate 1116 may be made of stainless steel with light resurface polishing. In other embodiments, epoxy 1106 is provided on the molded base 1104 as a directional guide that indicates to a user which direction to pull to release the magnetic zinger 1100 from one of the bases 200. The epoxy 1106 may be dyed blue or another color to make the directional guide more visible. In additional embodiments, a textured surface may be used in place of the epoxy 1106 to indicate the direction in which the user should pull to release the magnetic zinger 1100 from the base 200. By incorporating the magnetic plate 1116 into the magnetic zinger 1100, the magnetic zinger 1100 can be mounted, removed, and repositioned while remaining compatible with the previously described magnetic base arrangements.

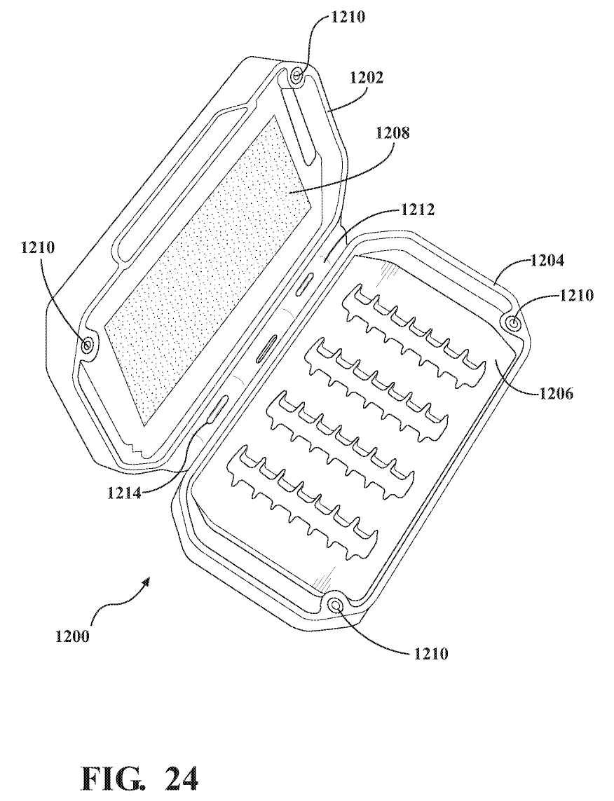

FIG. 24 illustrates a box 1200 for organizing fish bait and for use with the previously described accessory-and-base system. The box 1200 is shown in an open condition and includes a molded cover 1202, a molded base 1204, foam 1206, a magnetic pad 1208, corner magnets 1210, a hinge 1212, and a hinge pin 1214. The molded cover 1202 and the molded base 1204 cooperate to define a closable case structure that can store bait or other fishing-related items while also providing an organized interior arrangement. The hinge pin 1214 is received within the hinge 1212 and defines a pivot axis about which the molded cover 1202 is pivotable relative to the molded base 1204 between open and closed positions. The hinge pin 1214 may be made of stainless steel.

The foam 1206 is positioned within the box 1200 and can define an interior support or retention layer for bait, tackle, or other fishing accessories. The magnetic pad 1208 is positioned within the molded cover 1202 and can provide a magnetic retention surface for holding fishing components at selected interior locations. By incorporating the magnetic pad 1208 within the case, the box 1200 can help organize metallic items and reduce unintended movement of such items within the interior of the box 1200 during transport or use.

The corner magnets 1210 are positioned to assist in retaining the molded cover 1202 relative to the molded base 1204 when the box 1200 is in the closed position. The corner magnets 1210 can help maintain closure of the box 1200 and reduce unintended opening during storage, carrying, or movement of the box 1200. FIG. 24 therefore illustrates that the accessory system can include case-style accessories that provide both internal storage and magnetic organization features for fishing bait or related fishing components.

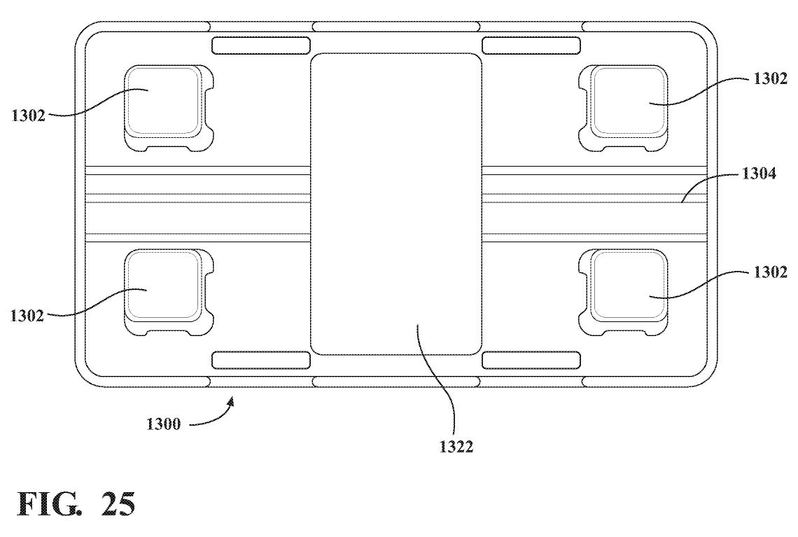

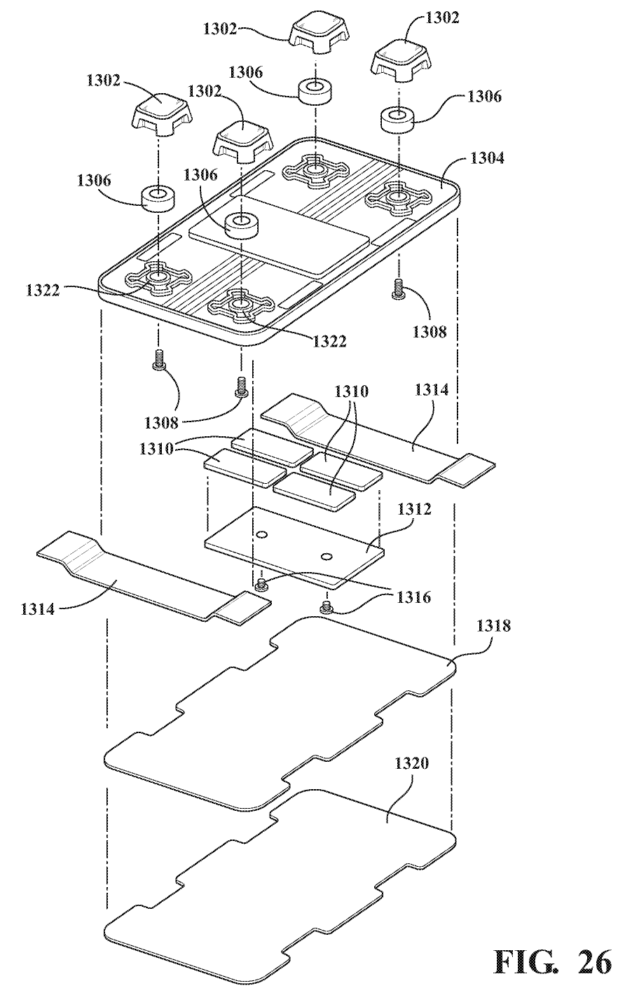

FIGS. 25 and 26 illustrate a magnetic work station 1300 for organizing fishing accessories. The magnetic work station 1300 includes a cap 1302 for magnets, a bottom 1304, a circle magnet 1306, a base screw 1308, a rectangular magnet 1310, a magnet holder 1312, a strap 1314, a magnet holder screw 1316, a backer sheet 1318, and tape 1320. The cap 1302 and the bottom 1304 cooperate to define a body of the magnetic work station 1300. The cap 1302 may define an outer upper portion of the body, and the bottom 1304 may define a lower support portion that supports the cap 1302 and the internal components of the magnetic work station 1300.

The circle magnet 1306 is positioned between the cap 1302 and the bottom 1304 to provide magnetic retention within the magnetic work station 1300. The cap 1302 is secured to the opening 1322 of the bottom 1304 such that the circle magnet 1306 is positioned between the cap and bottom 1304. The rectangular magnet 1310 is received in the magnet holder 1312, and the magnet holder 1312 is positioned within the bottom 1304 to support the rectangular magnet 1310 within the body of the magnetic work station 1300. The bottom 1304 is molded to include a portion 1322 that extends from the upper surface of the bottom 1304 and receives the rectangular magnet 1310 and the magnet holder 1312. The magnet holder screw 1316 extends through the magnet holder 1312 and into the bottom 1304 to secure the magnet holder 1312 to the bottom 1304. The base screw 1308 extends through the bottom 1304 and into the cap 1302 to secure the cap 1302 and the bottom 1304 together. In this arrangement, the cap 1302 covers the circle magnet 1306, the rectangular magnet 1310, and the magnet holder 1312, while the bottom 1304 supports the magnetic and fastening components to maintain the magnetic work station 1300 in an assembled configuration.

The strap 1314 is positioned along a lower side of the bottom 1304 and may provide a retention, carrying, fastening, or securing function for the magnetic work station 1300. The backer sheet 1318 is positioned beneath the strap 1314, and the tape 1320 is positioned beneath the backer sheet 1318 to assist in securing, spacing, or covering portions of the assembly.

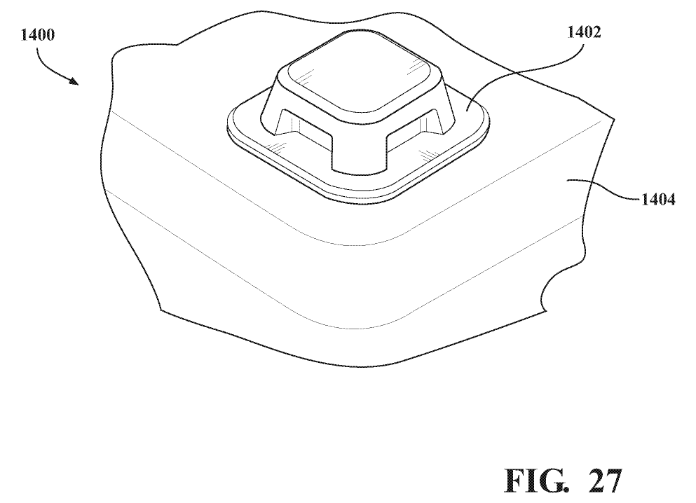

FIG. 27 illustrates a container device arrangement 1400 in which a magnetic base 1402 is mounted relative to a rigid object 1404. FIG. 27 demonstrates that the previously described magnetic base system is not limited to garments or flexible wearable articles and may also be implemented on rigid support structures. By positioning the magnetic base 1402 on the rigid object 1404, the rigid object 1404 can serve as a mounting platform for one or more accessories configured for releasable retention on the magnetic base 1402. In this manner, FIG. 27 illustrates that the accessory system can be adapted for use on containers, cases, boxes, coolers, or other rigid objects that a user may carry or position during fishing activity.

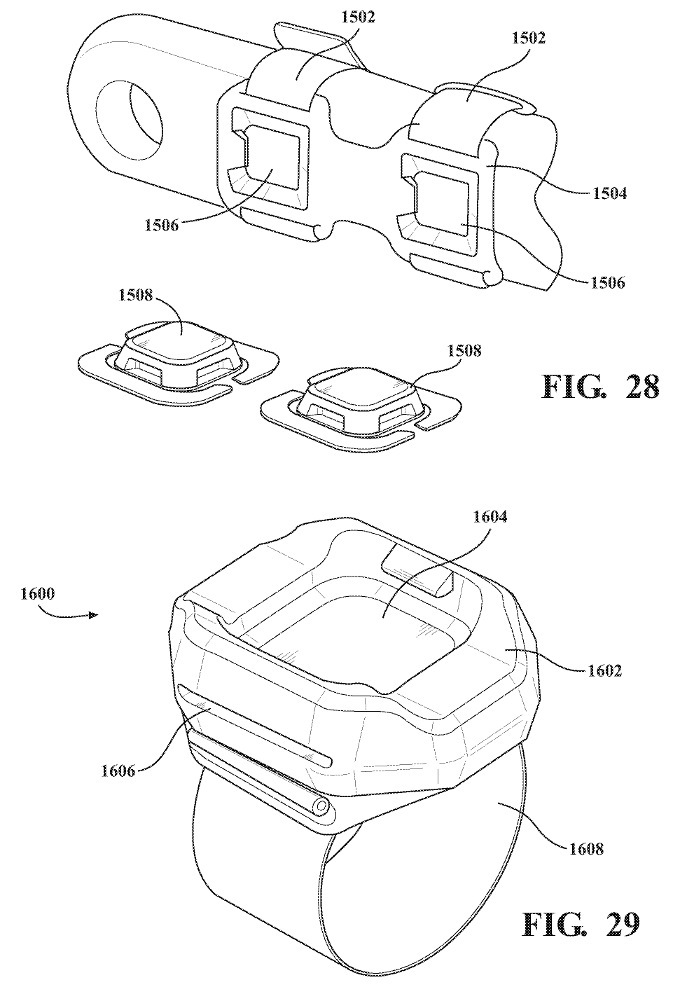

FIG. 28 illustrates a magnetic base strap holder 1500 in which a magnetic base 1508 can be retained relative to another article. The magnetic base strap holder 1500 includes a strap 1502, a molded cradle 1504, a molded tooth 1506, and the magnetic base 1508. In this manner, the accessory attachment arrangement 1500 provides another example of a support configuration for the magnetic base system.

With continued reference to FIG. 28, the strap 1502 extends through the molded cradle 1504 such that the accessory attachment arrangement 1500 can be secured to a supporting article. The molded cradle 1504 receives and supports the magnetic base 1508, with the magnetic base 1508 positioned on an outer side of the molded cradle 1504 to remain accessible for attachment to one or more accessories. The molded cradle 1504 also guides the strap 1502 through the molded cradle 1504 such that the strap 1502 can wrap around a handle or other support member. The molded tooth 1506 is positioned on the molded cradle 1504 and may engage the strap 1502 to help retain the strap 1502 in place and resist undesired sliding or loosening of the accessory attachment arrangement 1500.

FIG. 29 illustrates a magnetic dry shake holder 1600. The magnetic dry shake holder 1600 includes a molded base 1602, a magnetic plate 1604, and a strap 1608. The magnetic dry shake holder 1600 provides an accessory configured to retain a dry shake container or related item while also being adapted for attachment within the broader fishing accessory organization system.

The molded base 1602 defines a body of the magnetic dry shake holder 1600 and supports the magnetic plate 1604 on a lower side of the accessory . The magnetic plate 1604 is positioned along the molded base 1602 such that the magnetic dry shake holder 1600 can be magnetically and releasably retained on a compatible magnetic base 200. The magnetic plate 1604 may be made of stainless steel with light resurface polishing.

In other embodiments, epoxy 1606 is provided on the molded base 1602 as a directional guide that indicates to a user which direction to pull to release the magnetic dry shake holder 1600 from the bases 200. The epoxy 1606 may be dyed blue or another color to make the directional guide more visible. In additional embodiments, a textured surface may be used in place of the epoxy 1606 to indicate the direction in which the user should pull to release the magnetic dry shake holder 1600 from the bases 200.

The strap 1608 is coupled to the molded base 1602 and extends around a receiving area of the magnetic dry shake holder 1600 to retain a dry shake container or other article on the magnetic dry shake holder 1600.. In this manner, the strap 1608 can hold the supported article while the magnetic plate 1604 allows the magnetic dry shake holder 1600 to be mounted, removed, and repositioned relative to the base system. FIG. 29 therefore illustrates another accessory configuration in which an item-specific holder may be integrated into the modular accessory-and-base system.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. An assembly for organizing fishing accessories, the assembly comprising:
one or more bases, wherein the bases include a magnet and an attachment feature for coupling to a supporting device; and
a receptacle configured to be releasably connected to a selected one of the one or more bases, the receptacle comprising a flat portion including at least one receptacle magnet configured to magnetically couple the receptacle to the selected one of the one or more bases, and a receiving portion configured to support an item.

2. The assembly of claim 1, wherein the receptacle comprises a fly box having a bottom and a lid hinged to the bottom.

3. The assembly of claim 2, wherein the fly box defines an interior receiving portion between the bottom and the lid.

4. The assembly of claim 2, wherein the lid is movable relative to the bottom between an open position for internal access to the fly box and a closed position.

5. The assembly of claim 2, wherein the fly box comprises a plurality of corner magnets configured to retain the lid on the bottom in a closed position.

6. The assembly of claim 2, wherein the fly box comprises a foam insert mounted within the fly box.

7. The assembly of claim 2, wherein the flat portion is disposed on the bottom of the fly box.

8. The assembly of claim 2, wherein the at least one magnet of the flat portion is mounted to the bottom of the fly box.

9. The assembly of claim 2, wherein the lid comprises a plurality of base magnets configured to retain an item on an exterior of the lid.

10. The assembly of claim 2, wherein the fly box comprises a retractable pin configured to mechanically attach the fly box to another object.

11. A fly box for organizing fishing accessories, the fly box comprising:
a bottom;
a lid hinged to the bottom and configured to open the fly box for internal access;
a plurality of corner magnets to retain the lid on the bottom in a closed position;
a foam insert mounted to the lid, wherein the foam insert is configured to restrict movement of one or more fishing flies within the fly box when the lid is in the closed position;
a plurality of base magnets configured to retain an item on an exterior of the lid; and
at least one magnetic plate mounted to the bottom, wherein the at least one magnetic plate is configured to magnetically couple the fly box to a magnetic base.

12. The fly box of claim 11, wherein the lid is movable relative to the bottom between an open position for internal access to the fly box and a closed position.

13. The fly box of claim 11, wherein the lid is coupled to the bottom by a hinge and a hinge pin.

14. The fly box of claim 11, wherein a magnetic cover is mounted on an exterior of the lid and overlies the plurality of base magnets.

15. A system for organizing fishing accessories, the system comprising:
a garment having a pocket and apertures in the pocket;
one or more bases configured to be slidably inserted into the pocket and positioned through corresponding apertures in the pocket such that a proximal portion of each base is retained in the pocket, a distal portion of each base extends outwardly from the garment, and each base comprises a magnet and a clip; and
an accessory configured to be releasably retained on one of the bases or on two of the bases.

16. The system of claim 15, wherein the clips on the one or more bases are configured to mechanically retain the bases on other objects without magnetic force.

17. The system of claim 15, wherein the garment is a vest, shirt, sling, bag, pouch or backpack.

18. The system of claim 15, wherein the distal portions of the one or more bases have recesses that are complementary in shape to protrusions on the accessories.

19. The system of claim 15, wherein portions of the accessories and the distal portions of the one or more bases are complementary in shape, such that the accessories nest on the bases.

20. The system of claim 15, further comprising a bridge configured to nest with and connect the bases.
